(19) United States
(12) Patent Application Publication
(10) Pub. No.: US 2010/0201616 A1
(43) Pub. Date: Aug. 12, 2010

(54) SYSTEMS AND METHODS FOR CONTROLLING A DIGITAL IMAGE PROCESSING APPARATUS

(75) Inventors: Jun-ho Choi, Suwon-si (KR); Hye-jin Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/492,447

(22) Filed: Jun. 26, 2009

(30) Foreign Application Priority Data
Feb. 10, 2009 (KR) 10-2009-0010620

(51) Int. Cl. G09G 5/00; G06F 3/041

(52) U.S. Cl. 345/156; 345/173; 178/18.03

(57) ABSTRACT

A digital image processing apparatus includes a sensing unit configured to sense a user's gesture to perform a specific function and generate a signal representing the user's gesture. The digital image processing apparatus also includes a digital signal processing unit which receives the signal representing the user's gesture and recognizes a plurality of discontinuous gestures as one gesture when a temporal proximity threshold between a plurality of discontinuous gestures is met. The one gesture may represent an input command from the user.

### CROSS-REFERENCE TO RELATED PATENT APPLICATION

This application claims the priority benefit of Korean Patent Application No. 10-2009-0010620, filed on Feb. 10, 2009, in the Korean Intellectual Property Office, the disclosure of which is incorporated herein in its entirety by reference.

### BACKGROUND OF THE INVENTION

1. Field of the Invention

The present invention relates to systems and methods for controlling a digital image processing apparatus.

2. Description of the Related Art

Typically, a user operates buttons included in a body of a digital image processing apparatus, such as a digital camera, camcorder, or the like, in order to perform various functions of the digital image processing apparatus. For example, when a user desires to delete an image photographed by a digital camera, the user first presses a delete button included in the digital camera, and then presses a button corresponding to a window to confirm whether to delete the image or not. However, pressing buttons many times in order to perform a specific function may be inconvenient for the user.

### SUMMARY OF THE INVENTION

A digital image processing apparatus includes a sensing unit configured to sense a user's gesture to perform a specific function and generate a signal representing the user's gesture. The digital image processing apparatus also includes a digital signal processing unit which receives the signal representing the user's gesture and recognizes a plurality of discontinuous gestures as one gesture when a temporal proximity threshold between a plurality of discontinuous gestures is met. The one gesture may represent an input command from the user.

### BRIEF DESCRIPTION OF THE DRAWINGS

FIG. 1 is an exemplary block diagram of a digital image processing apparatus.

FIG. 2 is an exemplary block diagram of a digital signal processing unit of the digital image processing apparatus illustrated in FIG. 1.

FIGS. 3A and 3B illustrate an exemplary method of recognizing a gesture in the digital image processing apparatus illustrated in FIG. 1.

FIG. 4 is an alternative exemplary block diagram of a digital image processing apparatus.

FIGS. 5A and 5B illustrate an exemplary method of recognizing a gesture in the digital image processing apparatus illustrated in FIG. 4.

FIG. 6 is an exemplary flowchart of a method of controlling a digital image processing apparatus.

### DETAILED DESCRIPTION OF THE INVENTION

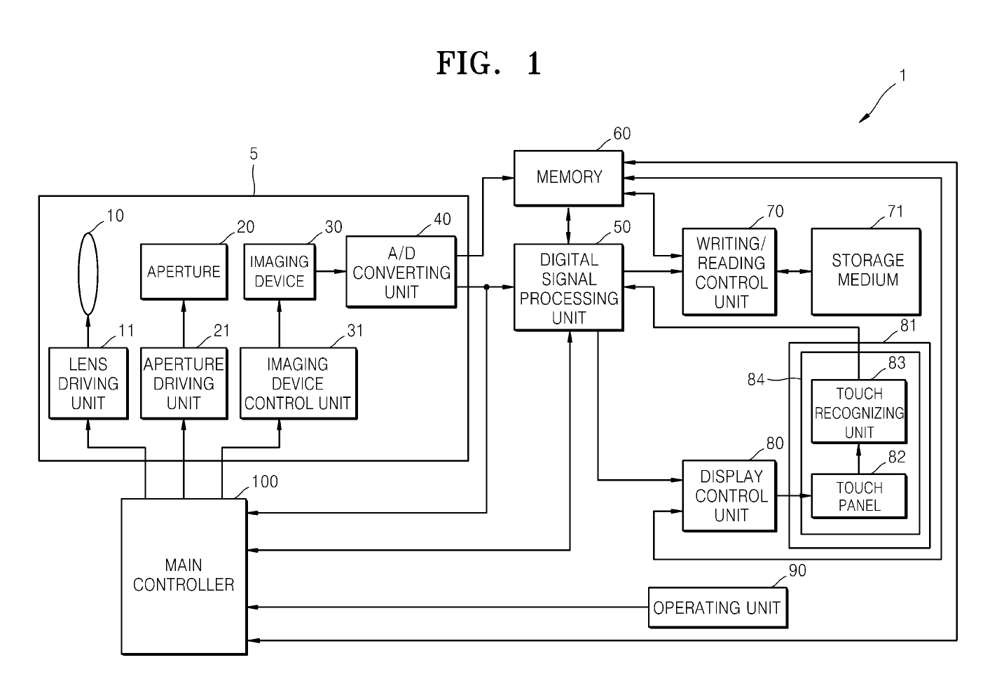

FIG. 1 is an exemplary block diagram of a digital image processing apparatus 1. The digital image processing apparatus 1 includes a photographing unit 5, a digital signal processing unit 50, a memory 60, a writing/reading control unit 70, a storage medium 71, a display control unit 80, a display unit 81, an operating unit 90, and a main controller 100.

The main controller 100 may control all operations performed by the digital image processing apparatus 1. The operating unit 90 may include a button configured to generate an electric signal when operated by a user. The electric signal generated by the operating unit 90 may be transmitted to the main controller 100. The main controller 100 may control the digital image processing apparatus 1 in response to the electric signal received from the operating unit 90.

The photographing unit 5 may capture an image of a subject when the digital image processing apparatus 1 is in a photographing mode. The photographing unit 5 may include a lens 10, a lens driving unit 11, an aperture 20, an aperture driving unit 21, an imaging device 30, an imaging device control unit 31, and an analog/digital (A/D) converting unit 40.

The lens driving unit 11 may control a focus by controlling a position of the lens 10 according to a control signal received from the main controller 100. The lens 10 may allow image light of the subject to pass therethrough and focus the image light onto the imaging device 30.

The aperture driving unit 21 may control an opening extent of the aperture 20 according to a control signal received from the main controller 100. The aperture 20 may control the amount of light from the lens 10 which passes through to the imaging device 30.

The imaging device control unit 31 may control the sensitivity of the imaging device 30 in response to a control signal received from the main controller 100. The imaging device 30 may convert the light which has passed through the lens 10 and the aperture 20 and onto the imaging device 30 into an electric signal. The imaging device 30 may include a complementary metal oxide semiconductor (CMOS), a charge coupled device (CCD), or the like to perform the conversion of the light into the electric signal. The electric signal may include an analog signal.

The imaging device 30 may output the electric signal converted from the light focused onto the imaging device 30 to the A/D converting unit 40. The A/D converting unit 40 may convert the electric signal from the imaging device 30 into a digital signal.

The A/D converting unit 40 may output the digital signal corresponding to the electric signal output from the imaging device 30. The digital signal may be output to the digital signal processing unit 50 directly. The A/D converting unit 40 may also output the digital signal to the memory 60, which may in turn output the digital signal to the digital signal processing unit 50. The memory 60 may include a read-only memory (ROM), a random-access memory (RAM), flash memory, or the like. The A/D converting unit 40 may output the digital signal to the main controller 100 also.

The digital signal processing unit 50 may perform digital signal processing, for example, gamma correction, white balance adjustment, noise removal, and the like.

The digital signal processing unit 50 may process the digital signal received from the A/D converting unit 40 and output image data to the writing/reading control unit 70 directly or to the memory 60. The digital signal processing unit 50 may also output the image data to the display control unit 80. The writing/reading control unit 70 may receive the image data directly from the digital signal processing unit 50, or retrieve the image data from the memory 60 when the image data has been previously stored by the digital signal processing unit 50 in the memory 60. The reading/writing control unit 70 may store the image data in a storage medium 71 automatically or according to a signal which is input by a user. The storage medium 71 may be removable or may be permanently attached to the digital image processing apparatus 1. The writing/reading control unit 70 may also read image data from an image file stored in the storage medium 71. The writing/reading control unit 70 may output the image data to the memory 60 or via another path such that the display control unit 80 may receive the image data.

The display control unit 80 may control the display unit 81 to display an image corresponding to the image data. The display control unit 80 may also receive the image data from the memory 60. In some embodiments, the display unit 81 may include a sensing unit 84 which may further include a touch panel 82 and a touch recognizing unit 83.

The sensing unit 84 may recognize a touch motion as a user's gesture. The touch motion may be input to the touch panel 82 from outside the digital image processing apparatus 1 by the user. The touch recognizing unit 83 may recognize the touch motion and output a signal corresponding to the touch motion to the digital signal processing unit 50. For example, when a user touches a surface of the touch panel 82 by using his or her finger, a pen, a stylus, or the like, the touch recognizing unit 83 may sense the user's touch motion and determine a kind of gesture which corresponds to the user's input touch motion.

The memory 60 or the storage medium 71 may store functions corresponding to various gestures in a table form. The main controller 100 may receive the signal generated in the gesture recognizing unit 54, and may generate a control signal for performing a function corresponding to the signal. The control signal may be transmitted to a component of the digital image processing apparatus 1 for performing the function. For example, when a user inputs a gesture for deleting an image file, the main controller 100 may generate a control signal for deleting the image file and transmit the generated control signal to the digital signal processing unit 50, the writing/reading control unit 70, or other appropriate components of the digital image processing apparatus 1 to delete the image file stored in the storage medium 71. Accordingly, in various embodiments of the digital image processing apparatus 1, a specific function may be easily performed by recognizing a gesture input by a user using a touch panel.

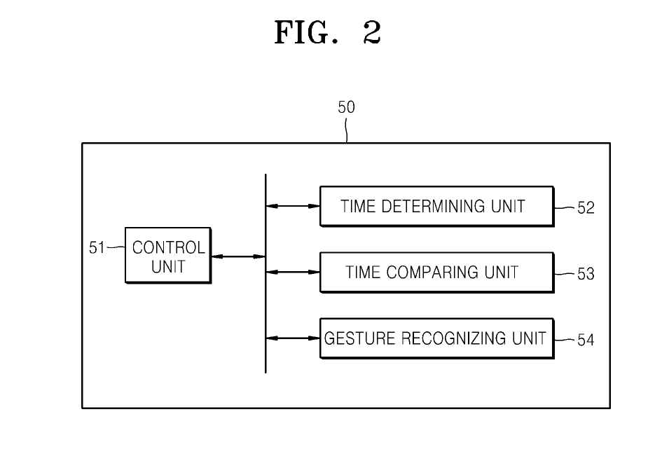

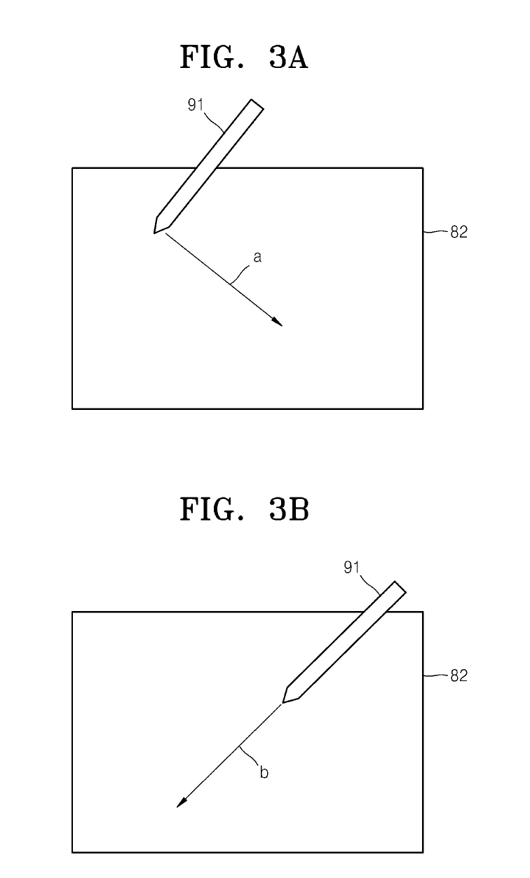

Hereinafter, a function of the digital signal processing unit 50 will be described with reference to FIGS. 2 through 3B.

FIG. 2 is an exemplary block diagram of the digital signal processing unit 50 of the digital image processing apparatus 1 illustrated in FIG. 1. The digital signal processing unit 50 includes a control unit 51, a time determining unit 52, a time comparing unit 53, and a gesture recognizing unit 54, all of which may be communicatively coupled with each other. Alternatively, these components of the digital signal processing unit 50 illustrated in FIG. 2 may be formed in various other ways, for example, by being separated from the digital signal processing unit 50 instead of being included inside the digital signal processing unit 50. For example, embodiments of the digital image processing apparatus 1 may include the control unit 51, the time determining unit 52, the time comparing unit 53, and/or the gesture recognizing unit 54 separate from and with or without the digital signal processing unit 50.

The control unit 51 controls general operations of each component included in the digital signal processing unit 50. The digital signal processing unit 50 may determine whether a plurality of gestures, which may be sensed in the sensing unit 84, are gestures corresponding to a single input command. When the touch recognizing unit 83 senses a plurality of gestures which are input by a user, the time determining unit 52 may determine a time interval between the plurality of gestures. For example, the time determining unit 52 may determine a time interval between the time when a first touch is finished and the time when a second touch is started. In order to determine the time interval, although not shown in the drawing, the digital image processing apparatus 1 may include a timer or other device configured to measure a time interval therein. Alternatively, a system clock which is used to perform signal synchronization in a main controller may be used in order to determine the time interval.

The time comparing unit 53 may compare the time interval between the plurality of gestures determined in the time determining unit 52 with a standard value. The standard value may be a condition for regarding the plurality of gestures as a serial operation corresponding to a single input command. For example, when the standard value is 0.5 seconds and the time interval determined in the time determining unit 52 is 0.3 seconds, the sensed plurality of gestures may be recognized as one gesture corresponding to a single input command. Alternatively, when the time interval determined in the time determining unit 52 is one second, each of the plurality of sensed gestures may be recognized as a gesture for a different input command. The time interval may represent a temporal proximity, and the standard value with which the determined time interval is compared may represent a proximity threshold.

The gesture recognizing unit 54 may generate a signal corresponding to the gestures sensed in the sensing unit 84 according to a result of the comparison performed by the time comparing unit 53. As a result of the comparison performed in the time comparing unit 53, when the time interval between the plurality of gestures is less than the standard value, a temporal proximity threshold between the plurality of gestures may be considered to be met and the gesture recognizing unit 54 may recognize the combination of the plurality of gestures as one gesture corresponding to a single input command. For example, the signal corresponding to the gestures may represent that the gestures which are input by a user are motions for deleting an image file when the gestures input by the user are sensed to be motions for deleting the image file.

FIGS. 3A and 3B illustrate an exemplary method of recognizing a gesture in the digital image processing apparatus 1 illustrated in FIG. 1. When a user draws a line a with a pen 91 from the left upper side to the right lower side of the touch panel 82, and then draws a line b from the right upper side to the left lower side within the standard time interval as determined by the time comparing unit 53, the gesture recognizing unit 54 may recognize the serial discontinuous gestures as one gesture representing a single input command. For example, the user's gestures described with reference to FIGS. 3A and 3B may be recognized as a gesture for deleting the image file. Accordingly, the gesture recognizing unit 54 may generate a signal representing that the gesture input by the user is a gesture for performing a function that deletes the image file. The generated signal may be transmitted to the main controller 100.

On the other hand, when the plurality of gestures sensed in the sensing unit are determined as one gesture, the gesture recognizing unit 54 may recognize the plurality of gestures as one gesture by using various methods.

In one of the methods, the plurality of gestures may be recognized as one gesture in consideration of the relative positions of the plurality of gestures which are input by the user. For example, the sensing unit including the touch panel 82 and the touch recognizing unit 83 may determine the positions of the plurality of gestures to be input. In this case, the gesture recognizing unit 54 may recognize the plurality of gestures as one gesture by using the relative positions between the plurality of gestures. For example, in the gestures described with reference to FIGS. 3A and 3B, an intersection point exists between the first gesture and the second gesture. Thus, the sensing unit senses the generation of the intersection point, and may recognize that the gesture is applied in an X-form, and thus may determine that the image file is to be deleted.

In another method, the gesture recognizing unit 54 may consider only a motion of each gesture, without considering the relative position of the gesture. For example, even though the lines a and b do not have an intersection when a user draws lines as illustrated in FIGS. 3A and 3B, the gesture recognizing unit 54 may recognize that the image file to be deleted, in consideration of only a direction that the lines drew.

In another method, as well as the combination of the plurality of gestures which are applied, the order in which the gestures are applied may be considered. For example, the gesture recognizing unit 54 may recognize a case where the gesture moving (movement performed by using the pen 91 or by moving the digital image processing apparatus itself) to the right is applied after the gesture moving to the left and a case where the gesture moving to the left is applied after the gesture moving to the right as different cases.

The method of recognizing the plurality of gestures as one gesture is exemplary, and the present invention is not limited thereto.

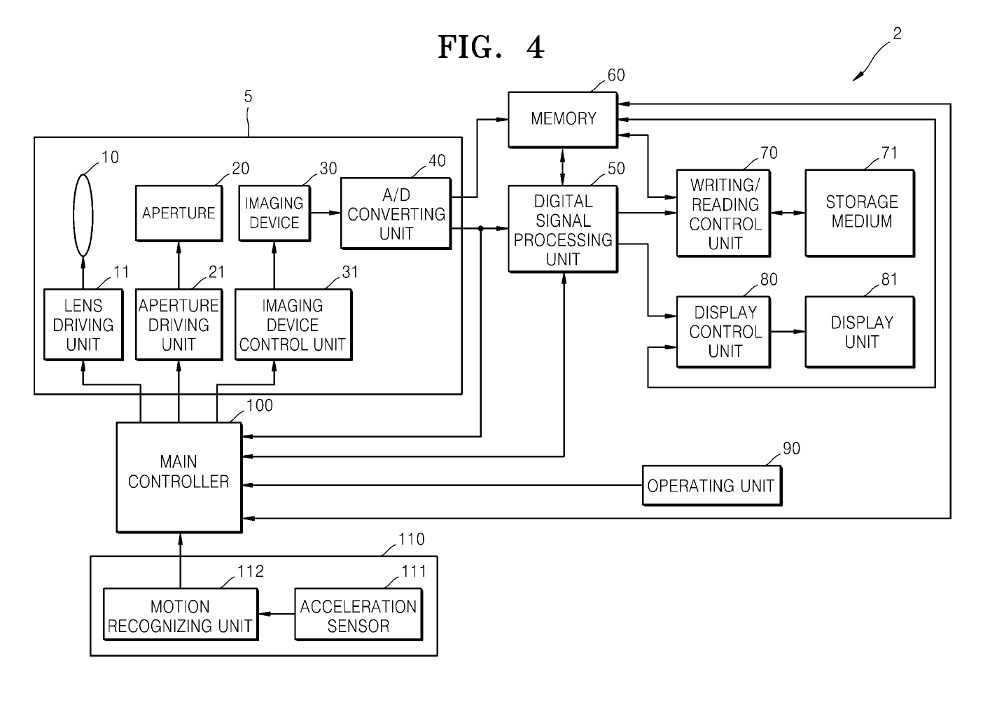

FIG. 4 is an alternative exemplary block diagram of a digital image processing apparatus 2. The digital image processing apparatus 2 may include a photographing unit 5, a digital signal processing unit 50, a memory 60, a writing/reading control unit 70, a storage medium 71, a display control unit 80, a display unit 81, an operating unit 90, a main controller 100, and a sensing unit 110. Hereinafter, differences between embodiments of the digital image processing apparatus 2 and the digital image processing apparatus 1 illustrated in FIG. 1 will be described.

The sensing unit 110 may include an acceleration sensor 111 and a motion recognizing unit 112. Using the sensing unit 110, a motion of the digital image processing apparatus 2 may be recognized as a user's input gesture. Accordingly, the acceleration sensor 111 and the motion recognizing unit 112 may have similar functions as the touch panel 82 and the touch recognizing unit 83 of FIG. 1, respectively.

The acceleration sensor 111 may sense a motion of the digital image processing apparatus 2. When the digital image processing apparatus 2 is physically moved or shaken by a user, the acceleration sensor 111 may sense the motion and generate an electric signal corresponding to the motion.

The motion recognizing unit 112 may analyze the electric signal generated in the acceleration sensor 111 and recognize the motion of the digital image processing apparatus 2. The motion recognizing unit 112 may determine a direction of motion of the digital image processing apparatus 2, generate a signal according to a result of the determination, and transmit the signal to the main controller 100. In other embodiments, the signal may be directly transmitted to the digital signal processing unit 50.

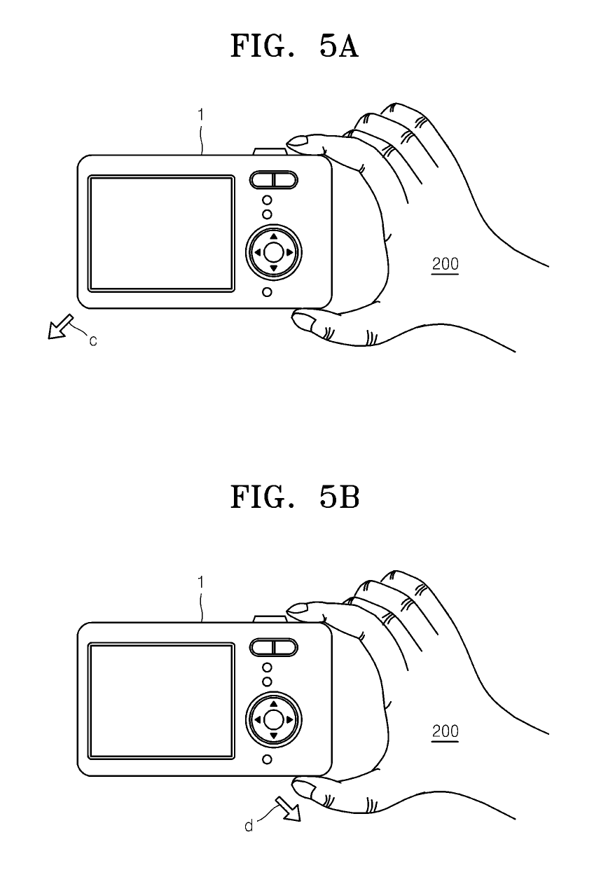

FIGS. 5A and 5B illustrate an exemplary method of recognizing a gesture in the digital image processing apparatus 2 illustrated in FIG. 4. FIGS. 5A and 5B illustrate the digital image processing apparatus 2 being held by a user's hand 200. Operations of the acceleration sensor 111 and the motion recognizing unit 112 will now be described in detail with reference to the exemplary method illustrated in FIGS. 5A and 5B.

In the exemplary method, a user may move or shake the digital image processing apparatus 2 in a direction c from the right upper side to the left lower side, representing a first gesture. The user may then move or shake the digital image processing apparatus 2 in a direction d from the left upper side to the right lower side, representing a second gesture which is discontinuous from the first gesture. The acceleration sensor 111 may sense the plurality of gestures, generate an electric signal with respect to each discontinuous gesture, and transmit each of the electric signals to the motion recognizing unit 112. The motion recognizing unit 112 may analyze each of the electric signals received from the acceleration sensor 111 and determine a corresponding direction of motion of the digital image processing apparatus 2.

In an embodiment, the time determining unit 52 and the time comparing unit 53 illustrated in FIG. 2 may determine whether the plurality of gestures represent one input signal or not using a signal corresponding to a result of the determination from the motion recognizing unit 112. A time interval or duration between the plurality of discontinuous gestures may represent a temporal proximity, and a standard time value with which the determined time interval is compared may represent a proximity threshold. The gesture recognizing unit 54 illustrated FIG. 2 may determine that the proximity threshold is met and recognize the serial discontinuous gestures as one gesture when the time interval is less than the standard time value.

For example, the user's discontinuous gestures described with reference to FIGS. 5A and 5B may be recognized as one gesture for deleting an image file. Accordingly, the gesture recognizing unit 54 may generate a signal representing that the discontinuous gestures which are input by the user are one gesture for performing a function that deletes the image file. The signal generated by the gesture recognizing unit 54 may be transmitted to the main controller 100.

In some embodiments, the motion recognizing unit 112 may transmit a signal regarding the motion of the digital image processing apparatus 2 directly to the digital signal processing unit 50. In other embodiments, the digital signal processing unit 50 may receive the signal regarding the motion of the digital image processing apparatus 2 indirectly through the main controller 100. The digital signal processing unit 50 may analyze the user's gesture by using the signal regarding the motion of the digital image processing apparatus 2. The analysis of the gesture has been described herein with reference to FIG. 2. Accordingly, in various embodiments of the digital image processing apparatus 2, a specific function may be easily performed by recognizing a plurality of discontinuous gestures input by a user using the acceleration sensor as one input signal.

In an exemplary method, the gesture recognizing unit 54 may consider only a direction of motion of each discontinuous gesture input by the user, without considering the relative position of each of the gestures. For example, even though the digital image processing apparatus 2 may be moved or shaken as illustrated in FIGS. 5A and 5B, the sensing unit 110 may not easily determine whether an intersection point between the discontinuous gestures exists or not. However, regardless of whether an intersection point is determined, the sensing unit 110 may recognize the combination of discontinuous gestures as indicating that the image file is to be deleted, in consideration of only a direction of motion of the digital image processing apparatus 2.

In another exemplary method, in addition to the combination of the plurality of discontinuous gestures input by the user, a sequential order in which the discontinuous gestures are input may be considered to determine a function corresponding to a combination of the discontinuous gestures. For example, the gesture recognizing unit 54 may recognize a case where a user's gesture of moving to the right (e.g., movement performed by using the pen 91 or by moving the digital image processing apparatus 2 itself) is applied after a user's gesture of moving to the left as one gesture for a first function, and a case where the user's gesture of moving to the left is applied after the user's gesture of moving to the right as one gesture for a different function.

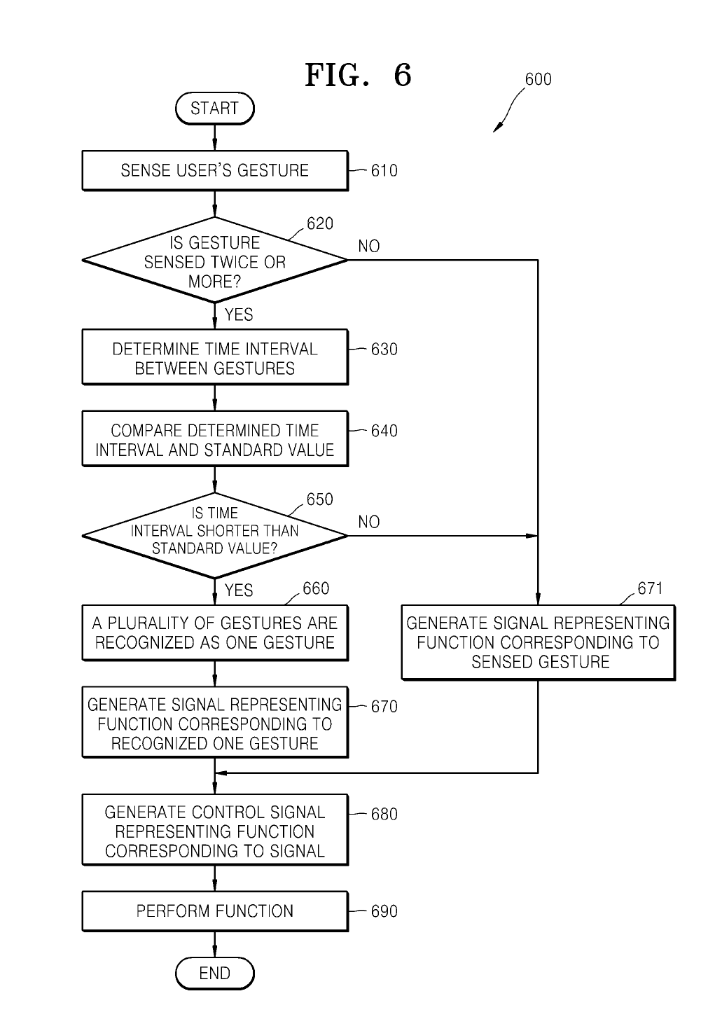

FIG. 6 is an exemplary flowchart of a method of controlling a digital image processing apparatus 1, 2. In step 610, a user's gesture may be sensed by a sensing unit when a user makes an arbitrary gesture. In step 620, the sensing unit may determine whether the user's gesture is sensed more than twice. When the user's gesture is sensed only once, a signal representing a function corresponding to the sensed gesture may be generated in step 671.

However, when the user's gesture is sensed twice or more, a time interval between the sensed gestures may be determined in step 630. The time interval may be measured as a time duration between when a formerly sensed gesture is finished to when a subsequently sensed gesture is started. In step 640, the time interval may be compared with a standard value. In step 650, a determination as to whether the time interval is less (e.g., shorter) than the standard value may be made.

When the time interval is not less than the standard value, a plurality of signals, each of the plurality of signals representing a function corresponding to one of the plurality of gestures sensed, may be generated in step 671 on the supposition that each of the plurality of gestures sensed represents a separate input command. However, when the time interval is less than the standard value, the plurality of gestures may be recognized as one gesture corresponding to the input command in step 660.

For example, a user's gesture in which the digital image processing apparatus 2 is shaken to the left while the digital processing apparatus 2 is operating in a reproducing mode may represent that an image file being displayed by the digital image processing apparatus 2 is to be changed to the next image file in a sequence of image files. When the user shakes the digital image processing apparatus 2 in this way twice, and both discontinuous shaking gestures are performed within a time interval greater than the standard value, an operation for changing the image file being displayed to the next image file may be performed twice. Alternatively, when the user shakes the digital image processing apparatus 2 in this way twice within a time interval less than the standard value, an entirely different function may be performed than changing the image file being displayed. For example, a slide show may be displayed for viewing by the user, or a folder containing images to be reproduced may be changed.

When the plurality of discontinuous gestures are recognized as one gesture corresponding to a single input command in step 660, a signal representing a function corresponding to the recognized one gesture (i.e., a combination of the plurality of discontinuous gestures) is generated in step 670.

The main controller, or another component of the digital image processing apparatus 1, 2, may receive the signal generated in either step 670 or step 671 and consequently generate a control signal for performing a function corresponding to the signal generated for each gesture or combination of discontinuous gestures in step 680. In step 690, the function corresponding to the control signal generated in step 680 is performed. Accordingly, in various embodiments, a specific function that a user desires to perform may be easily performed without the user having to operate buttons included in a digital image processing apparatus.

A program for executing a method of controlling a digital image processing apparatus according to the aforementioned embodiments and modified examples in the digital image processing apparatus may be stored in a computer readable storage medium. The computer readable storage medium may include the memory 60 or the storage medium 71 as illustrated in FIG. 1 or 4. The computer readable storage medium may also include a storage medium, such as a magnetic storage medium (for example, a magnetic tape, a floppy disk, or a hard disk), an optical recording medium (for example, a compact disc (CD)-ROM or a digital versatile disk (DVD)), or an integrated circuit (for example, a ROM or an EPROM). For example, the computer readable storage medium may include the main controller 100 illustrated in FIG. 1 or 4 or a part of the main controller 100.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. It will be recognized that the terms “comprising,” “including,” and “having,” as used herein, are specifically intended to be read as open-ended terms of art.

What is claimed is:

1. A digital image processing apparatus comprising:
a sensing unit configured to sense a user's gesture to perform a specific function and generate a signal representing the user's gesture; and
a digital signal processing unit which receives the signal representing the user's gesture and recognizes a plurality of discontinuous gestures as one gesture when a temporal proximity threshold between the plurality of discontinuous gestures is met.

2. The digital image processing apparatus of claim 1, wherein the sensing unit senses a touch from outside the digital image processing apparatus, and the touch is recognized as the user's gesture.

3. The digital image processing apparatus of claim 2, wherein the sensing unit comprises:
a touch panel to which a user inputs a touch from outside the digital image processing apparatus; and
a touch recognizing unit which recognizes the touch input to the touch panel and generates the signal representing the user's gesture.

4. The digital image processing apparatus of claim 1, wherein the sensing unit senses a motion of the digital image processing apparatus, and the motion is recognized as the user's gesture.

5. The digital image processing apparatus of claim 4, wherein the sensing unit comprises:
an acceleration sensor which senses a motion of the digital image processing apparatus and outputs a signal representing the motion; and
a motion recognizing unit which analyzes the signal from the acceleration sensor, recognizes the motion of the digital image processing apparatus as the user's gesture, and generates the signal representing the user's gesture.

6. The digital image processing apparatus of claim 1, wherein the digital signal processing unit comprises:
a time determining unit that determines a time interval between the plurality of discontinuous gestures;
a time comparing unit that compares the time interval between the plurality of discontinuous gestures with a standard value to determine whether the time interval is less than or greater than the standard value; and
a gesture recognizing unit which determines that the proximity threshold is met when the time interval is less than the standard value and recognizes the plurality of discontinuous gestures as one gesture.

7. The digital image processing apparatus of claim 6, wherein the gesture recognizing unit considers the relative positions of the plurality of gestures when recognizing the plurality of discontinuous gestures as one gesture.

8. The digital image processing apparatus of claim 6, wherein the gesture recognizing unit considers the order of the plurality of gestures input when recognizing the plurality of discontinuous gestures as one gesture.

9. The digital image processing apparatus of claim 1, further comprising a main controller which generates a control signal for performing the specific function corresponding to the one gesture recognized in the digital signal processing unit.

10. A method of controlling a digital image processing apparatus configured to sense a user's gesture to perform a specific function, the method comprising:
sensing a plurality of discontinuous gestures input by a user;
measuring a temporal proximity between the plurality of discontinuous gestures;
recognizing the plurality of discontinuous gestures as one gesture when the temporal proximity is less than a standard value; and
performing a specific function corresponding to the recognized one gesture.

11. The method of claim 10, wherein sensing the plurality of discontinuous gestures comprises recognizing a user's touch from outside the digital image processing apparatus.

12. The method of claim 10, wherein sensing the plurality of discontinuous gestures comprises recognizing a motion of the digital image processing apparatus.

13. The method of claim 10, wherein recognizing the plurality of discontinuous gestures as one gesture consider the relative positions of the plurality of gestures.

14. The method of claim 10, wherein recognizing the plurality of discontinuous gestures as one gesture consider the order of the plurality of gestures input.

15. A computer readable storage medium having stored thereon a computer program, the computer program executable by a processor to perform a method of controlling a digital image processing apparatus configured to sense a user's gesture to perform a specific function, the method comprising:
sensing a plurality of discontinuous gestures input by a user;
measuring a temporal proximity between the plurality of discontinuous gestures;
recognizing the plurality of discontinuous gestures as one gesture when the temporal proximity is less than a standard value; and
performing a specific function corresponding to the recognized one gesture.

16. The computer readable storage medium of claim 15, wherein sensing the plurality of discontinuous gestures comprises recognizing a user's touch from outside the digital image processing apparatus.

17. The computer readable storage medium of claim 15, wherein sensing the plurality of discontinuous gestures comprises recognizing a motion of the digital image processing apparatus.

18. The computer readable storage medium of 15, wherein recognizing the plurality of discontinuous gestures as one gesture consider the relative positions of the plurality of gestures.

19. The computer readable storage medium of 15, wherein recognizing the plurality of discontinuous gestures as one gesture consider the order of the plurality of gestures input.
